(19) United States
(12) Patent Application Publication
(10) Pub. No.: US 2011/0266975 A1
(43) Pub. Date: Nov. 3, 2011

(54) ILLUMINATION CONTROLLER AND ILLUMINATION DRIVING SYSTEM

(75) Inventors: Chung-Che Yu, New Taipei City (TW); Li-Min Lee, New Taipei City (TW); Shian-Sung Shiu, New Taipei City (TW)

(73) Assignee: GREEN SOLUTION TECHNOLOGY CO., LTD., New Taipei City (TW)

(21) Appl. No.: 13/089,329

(22) Filed: Apr. 19, 2011

(30) Foreign Application Priority Data
Apr. 29, 2010 (TW) 099113588

(51) Int. Cl. H05B 37/02

(52) U.S. Cl. 315/307

(57) ABSTRACT

An illumination controller adapted to control a converting circuit to convert an electric power of a DC input power source to drive a light source is provided. The illumination controller includes a dimming unit and a control unit. The dimming unit receives a dimming signal and correspondingly generates a dimming control signal according to the number of the dimming signal. The control unit controls the electric power provided to the light source by the converting circuit according to the dimming control signal, so as to adjust a brightness of the light source. Furthermore, an illumination driving system is also provided.

### CROSS-REFERENCE TO RELATED APPLICATION

This application claims the priority benefit of Taiwan application serial no. 099113588, filed Apr. 29, 2010. The entirety of the above-mentioned patent application is hereby incorporated by reference herein and made a part of this specification.

### BACKGROUND OF THE INVENTION

1. Field of the Invention

The invention relates to an illumination controller and an illumination driving system. More particularly, the invention relates to an illumination controller and an illumination driving system with dimming function.

2. Description of Related Art

FIG. 1 is a schematic circuit of a conventional electronic fluorescent lamp illumination system. Referring to FIG. 1, the fluorescent lamp illumination system includes a ballast controller 10, a DC/AC converting circuit 60, a fluorescent lamp 70, a bridge rectifier 80, and a lamp switch 90. Users turn on the lamp switch 90 such that an AC power VAC is coupled to the bridge rectifier 80 through the lamp switch 90 and rectified as a DC voltage. The DC/AC converting circuit 60 receives the DC voltage and converts an electric power of the DC voltage into an AC voltage with a high frequency according to the control of the ballast controller 10, so as to drive the fluorescent lamp 70 to emit light.

Generally, the fluorescent lamp illumination system has no dimming function, and the users can not adjust the brightness of the fluorescent lamp 70 based on the practice requirement. If the dimming function is required, a dimming knob 95 can be added to the lamp switch 90. By regulating the resistance of the variable resistor of the dimming knob 95, the users can adjust the level of a DC dimming signal DCDIM. The ballast controller 10 receives the DC dimming signal DCDIM to control the value of the electric power of the DC/AC converting circuit 60 for driving the fluorescent lamp 70 according to the level of the DC dimming signal DCDIM, such that the dimming function is achieved.

However, in order to transmit the DC dimming signal DCDIM to the ballast controller 10, an additional signal path 15 is required being connected the dimming knob 95 with the ballast controller 10. Generally, the ballast controller 10 and the fluorescent lamp 70 are assembled together on a ceiling, and the dimming knob 95 and the lamp switch 90 are assembled on a wall. Accordingly, the distance between the ballast controller 10 and the dimming knob 95 is quite long. In order to add the dimming function to the conventional electronic fluorescent lamp illumination system, besides the complexity of assembling the circuit is increased, the additional signal path 15 and the dimming knob 95 are also required, such that the whole cost is increased.

### SUMMARY OF THE INVENTION

In the foregoing related art, when the dimming function is added to the fluorescent lamp illumination system, the complexity of assembling the circuit and the cost of the circuit are increased. Accordingly, in an exemplary embodiment of the invention, by counting the switching number of the lamp switch, the brightness of the illumination system is adjusted, and further, the dimming signal is simply transmitted by the original power supply path instead of the additional signal path. Moreover, the complexity of assembling the circuit and the cost of the circuit are relatively low.

Accordingly, an exemplary embodiment of the invention provides an illumination controller adapted to control a converting circuit to convert an electric power of a DC input power source to drive a light source. The illumination controller includes a dimming unit and a control unit. The dimming unit receives a dimming signal and correspondingly generates a dimming control signal according to the number of level change of the dimming signal. The control unit controls the electric power provided to the light source by the converting circuit according to the dimming control signal, so as to adjust a brightness of the light source.

Furthermore, another exemplary embodiment of the invention provides an illumination driving system adapted to drive a light source. The illumination driving system includes a converting circuit and an illumination controller. The converting circuit is coupled to a DC input power source and converts an electric power of the DC input power source to drive the light source to emit light. The illumination controller generates at least one control signal to control the converting circuit. Herein, the illumination controller detects a voltage of the DC input power source to control the electric power of the converting circuit for driving the light source according to the number of voltage change of the DC input power source, so as to adjust a brightness of the light source.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit of a conventional electronic fluorescent lamp illumination system.

FIG. 2 is a circuit block diagram of an illumination driving system according to an embodiment of the invention.

FIG. 3 is a schematic circuit of an illumination driving system according to a first embodiment of the invention.

FIG. 4 is a schematic circuit of an illumination driving system according to a second embodiment of the invention.

FIG. 5 is a schematic circuit of an illumination driving system according to a third embodiment of the invention.

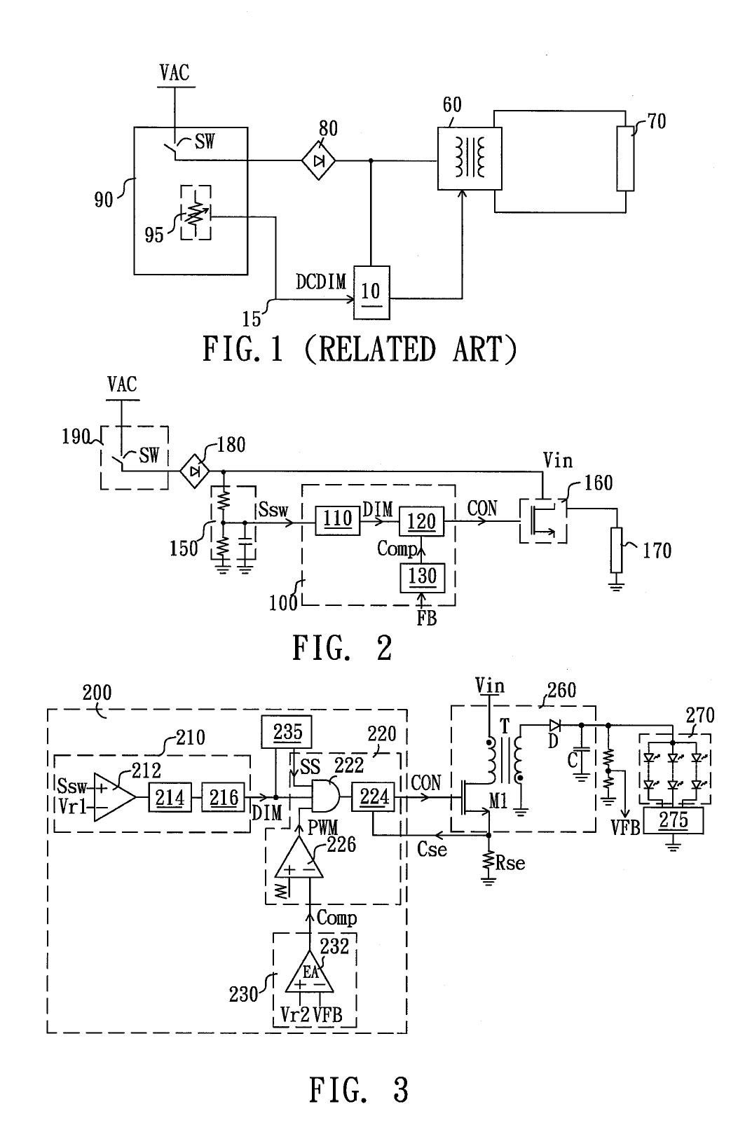

### DESCRIPTION OF EMBODIMENTS

FIG. 2 is a circuit block diagram of an illumination driving system according to an embodiment of the invention. Referring to FIG. 2, the illumination driving system includes an illumination controller 100 and a converting circuit 160. The converting circuit 160 receives a DC input power source Vin and converts the DC input power source Vin into an output voltage so as to drive a light source 170. In the present embodiment, the DC input power source Vin is generated from an AC voltage VAC by a bridge rectifier 180, wherein the bridge rectifier 180 may comprise an input capacitor (not shown) for filtering the ripple of the rectified voltage, and the input capacitor may be coupled to the bridge rectifier 180 before or after a dimming converting circuit 150. The converting circuit 160 is coupled to the DC input power source Vin and converts an electric power of the DC input power source Vin into a suitable driving power to drive the light source 170. The illumination controller 100 receives a feedback detecting signal FB and generates a control signal CON according to the feedback detecting signal FB to control the value of the electric power transmitted from the converting circuit 160 to the light source 170, so that electric characteristics of the light source 170, such as the voltage drop applied across the light source 170 or the current flowing through the light source 170, are maintained about a predetermined value. Furthermore, the illumination controller 100 is coupled to the DC input power source Vin and detects the voltage of the DC input power source Vin, so as to determine the duty ratio according to the number of voltage change of the DC input power source Vin, and perform the dimming process in the burst mode to adjust the brightness of the light source 170.

The illumination controller 100 includes a dimming unit 110 and a control unit, wherein the control unit includes a duty cycle control circuit 120 and a feedback unit 130. The dimming unit 110 detects the voltage of the DC input power source Vin to convert the voltage change of the DC input power source Vin into a dimming control signal DIM. Accordingly, users can transmit the required dimming ratio to the illumination controller 100 in a manner corresponding to the voltage change of the DC input power source Vin by switching a switch 190, for example. Herein, the switch 190 is coupled to the DC input power source Vin and may be an illumination switch assembled on the wall. The users couple or dis-couple the DC input power source Vin to the illumination driving system by switching the switch 190, so as to control the AC voltage VAC whether to be coupled to the light source 170. That is, the users can control the light source 170 to be turned on or off. Accordingly, in the illumination driving system of the present embodiment, the electric power used to drive the light source 170 and the dimming information can be transmitted through the same line, and the additional circuit is unnecessary. Furthermore, the users may also transmit the dimming information through an additional circuit to the illumination controller 100, and the illumination controller 100 can still perform the dimming function according to the dimming information.

The feedback unit 130 receives a feedback detecting signal FB representing the state of the light source 170 to generate a feedback signal Comp to the duty cycle control circuit 120 according to the feedback detecting signal FB. Herein, the feedback detecting signal FB may represent the amount of the voltage or the current which is applied to the light source 170 by the converting circuit 160. The duty cycle control circuit 120 adjusts the duty cycle of the control signal CON according to the feedback signal Comp, and accordingly adjusts a value of the electric power provided to the light source 170 by the converting circuit 160. Therefore the voltage or the current applied to the light source 170 by the converting circuit 160 is stabilized about a predetermined value. In the present embodiment, the dimming converting circuit 150 coupled to the DC input power source Vin may be added as shown in FIG. 2. In the present embodiment, the dimming converting circuit 150 is formed by two resistors and a capacitor and converts the voltage change of the DC input power source Vin into a dimming signal Ssw. The capacitor can avoid erroneous determination due to noise interference, and the two resistors serve as a voltage divider which can convert the voltage of the DC input power source Vin into a voltage with a lower and suitable level and further provide the voltage to the illumination controller 100, so as to lower the voltage endurance requirement of the illumination controller 100. The dimming unit 110 receives the dimming signal Ssw to count the number of the dimming signal Ssw and generates the dimming control signal DIM corresponding to the dimming ratio according to the number of the dimming signal Ssw. The dimming unit 110 can determine the number of the dimming signal Ssw according to a predetermined level and counts the number of the dimming signal Ssw when the level of the dimming signal Ssw is higher than the predetermined level. For example, in a four-stage dimming process, when the switch 190 is not switched after being turned on by the users, the number of the dimming signal Ssw is 0, and the dimming ratio is 100%; and when the switch 190 is switched once after being turned on by the users, the number of the dimming signal Ssw is 1, and the dimming ratio is 75%. Accordingly, when the number of the dimming signal Ssw is 2, the dimming ratio is 50%; when the number of the dimming signal Ssw is 3, the dimming ratio is 25%; when the number of the dimming signal Ssw is 4, the dimming ratio is 100% again; and so forth. In practice application, the dimming stage can be determined as two or more than two stages according to usage environments.

In addition, the dimming signal Ssw may be generated by another manner. For example, the dimming signal Ssw may be generated by another switch for dimming assembled on the wall for the users touching or switching the dimming switch to dim the light source 170.

FIG. 3 is a schematic circuit of an illumination driving system according to a first embodiment of the invention. Referring to FIG. 3, the illumination driving system includes an illumination controller 200 and a converting circuit 260. The converting circuit 260 receives a DC input power source Vin and converts the DC input power source Vin into an output voltage so as to drive a light source 270. In the present embodiment, the converting circuit 260 is a flyback converting circuit including a switch SW, a transformer T, a rectifying diode D, and an output capacitor C. The light source 270 is a light emitting diode (LED) module including a plurality of LED strings coupled in parallel, and the light source 270 is coupled to the converting circuit 260 to receive the electric power required for light emitting. In order to uniform the brightness of each LEDs in the light source 270, the light source 270 may be coupled with a current balancing element 275 to uniform the currents flowing through the LED strings.

The illumination controller 200 includes a dimming unit 210 and a control unit, wherein the control unit includes a duty cycle control circuit 220 and a feedback unit 230. The dimming unit 210 receives a dimming signal Ssw and correspondingly generates a dimming control signal DIM according to the number of the dimming signal Ssw. The dimming signal Ssw may be a signal generated by touching or switching a switch, or by touching the pin of the illumination controller 200 for receiving the dimming signal Ssw. The feedback unit 230 receives a voltage feedback detecting signal VFB representing the value of the output voltage Vout of the converting circuit 260 and accordingly generates a feedback signal Comp, wherein the voltage feedback detecting signal VFB is generated by a voltage divider coupled to the output end of the converting circuit 260. The duty cycle control circuit 220 is coupled to the dimming unit 210 and the feedback unit 230 to receive the dimming control signal DIM and the feedback signal Comp. Accordingly duty the cycle control circuit 220 generates a control signal CON to switch the switch M1 of the converting circuit 260. Accordingly, the duty cycle control circuit 220 controls the electric power provided to the light source 270 by the converting circuit 260. The dimming unit 210 includes a comparator 212, a counting circuit 214, and a dimming control signal generator 216. The comparator 212 receives the dimming signal Ssw and a first reference voltage signal Vr1 and generates an output with the high level when the level of the dimming signal Ssw is higher than that of the first reference voltage signal Vr1. According to the number of the dimming signal Ssw, the users, for example, switch the switch of the illumination driving system on the wall, and thus, the comparator 212 generates signals with the high level of which the number corresponds to that of the dimming signal Ssw to the counting circuit 214. The counting circuit 214 counts the number of the signals with the high level generated by the comparator 212 and transmits the information about the counted number to the dimming control signal generator 216. In addition, the counting circuit 214 may reset the number and count again due to reset or when the illumination controller 200 is re-started. The dimming control signal generator 216 generates the dimming control signal DIM to the duty cycle control circuit 220 according to the information about the counted number of the counting circuit 214.

The feedback unit 230 includes an error amplifier 232 and receives a voltage feedback detecting signal VFB and a second reference voltage Vr2 to generate a feedback signal Comp to the duty cycle control circuit 220. The duty cycle control circuit 220 includes an AND gate 222, a driving circuit 224, and a pulse width modulation (PWM) circuit 226. The PWM circuit 226 receives a ramp signal and the feedback signal Comp so as to generate a PWM signal PWM to the AND gate 222. The AND gate 222 receives the dimming control signal DIM and the PWM signal PWM and generates an output signal after the “AND” operation. The driving circuit 224 is coupled to a current detecting resistor Rse coupled to the switch M1 of the converting circuit 260 to receive a current detecting signal Cse and the output signal of the AND gate 222 to generate a control signal CON to control the state of the switch M1 of the converting circuit 260. When the switch M1 is turned on by the illumination controller 200, the electric power from the DC input power source Vin is stored in the transformer T and an electric power stored in the output capacitor C is provided to drive the light source 270. When the switch M1 is turned off, the electric power from the DC input power source Vin is stopped and the stored electric power in the transformer T is released to be stored in the output capacitor C and drive the light source 270. Accordingly, the output voltage Vout of the converting circuit 260 is stabilized. Furthermore, the illumination controller 200 may further include a soft-start circuit 235. The soft-start circuit 235 outputs a soft-start signal SS to the AND gate 222 at start, such that the illumination controller 200 starts a soft-start function to avoid ripples of the output current or the output voltage at start. When the illumination controller 200 performs the dimming process in the burst dimming, the soft-start circuit 235 may be reset during the “OFF” state of the dimming cycle and be started at start of the “ON” state of the dimming cycle to avoid the ripples of the current or the voltage in the dimming process.

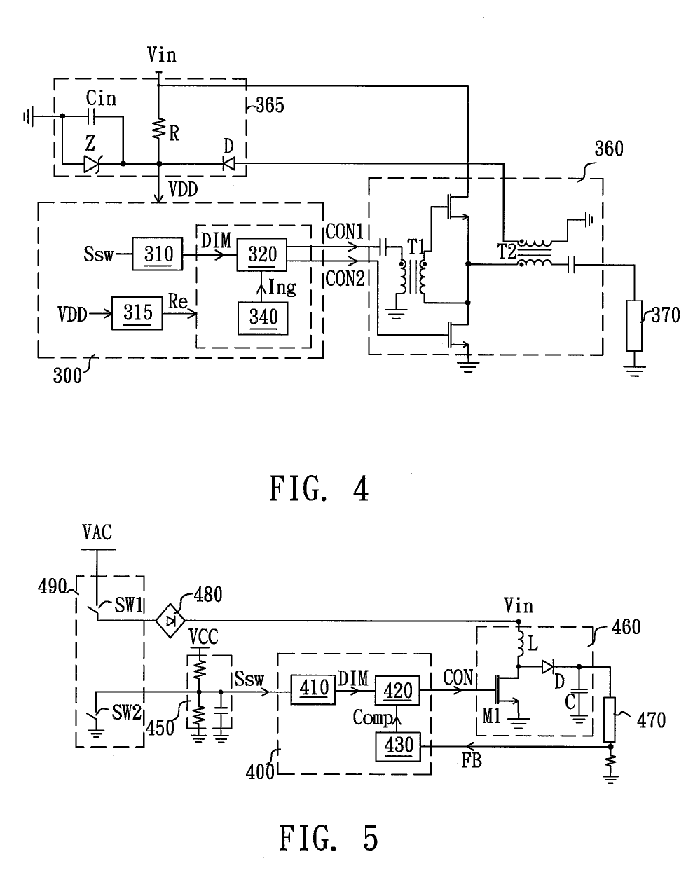

FIG. 4 is a schematic circuit of an illumination driving system according to a second embodiment of the invention. Referring to FIG. 4, the illumination driving system includes an illumination controller 300 and a converting circuit 360. The converting circuit 360 receives a DC input power source Vin and converts the DC input power source Vin into an output voltage so as to drive a light source 370. In the present embodiment, the light source 370 is a discharging lamp module, such as a cold cathode fluorescent lamp (CCFL) module, a hot cathode fluorescent lamp (HCFL) module, and so on. The converting circuit 360 mainly includes a driving transformer T1, a transformer T2, and two switches coupled in series between the DC input power source DC and ground. The illumination controller 300 generates two control signals CON1 and CON2 to respectively control the states of the two switches, so as to control the value of the electric power provided to the light source 370 by the converting circuit 360. The illumination controller 300 includes a dimming unit 310 and a control unit, wherein the control unit includes a duty cycle control circuit 320 and a lighting driving unit 340. Compared with the circuit shown in FIG. 3, the illumination driving system of the present embodiment performs the feedback control without the feedback detecting signal. Instead, the lighting driving unit 340 generates an ignition driving signal Ing according to a predetermined lighting procedure, so as to first preheat the discharging lamp of the light source 370, then scan frequency to light the discharging lamp, and finally maintain the operation frequency to stabilize the brightness of the discharging lamp.

The dimming unit 310 receives a dimming signal Ssw and correspondingly generates a dimming control signal DIM according to the number of the dimming signal Ssw. The duty cycle control circuit 320 receives the ignition driving signal Ing and the dimming control signal DIM to generate the control signals CON1 and CON2 to respectively control the states of the two switches in the converting circuit 360. Furthermore, the dimming process is performed when the light source 370 stably emits light to avoid affecting the ignition of the light source 370 due to the dimming process. Accordingly, the duty cycle control circuit 320 can simply perform the dimming process according to the dimming control signal DIM when the light source 370 stably emits light. In the present embodiment, a predetermined time period can be set in the duty cycle control circuit 320. The duty cycle control circuit 320 simply determines whether the light source 370 stably emits light after starting for the predetermined time period, i.e. after the lighting driving unit 340 finishes the lighting procedure. Alternatively, as the embodiment shown in FIG. 3, the duty cycle control circuit 320 can determine whether the light source stably emits light according to the voltage/current feedback detecting signal. If so, the duty cycle control circuit 320 simply starts to adjust the value of the electric power provided to the light source by the converting circuit.

Furthermore, in the present embodiment, the electric power required by the illumination controller 300 for operation and the driving electric power of the light source 370 are both provided from the DC input power source Vin. When the users input the dimming information by the switch of the illumination driving system, the illumination controller 300 may stop operation because the voltage of the DC input power source Vin fall down to zero. In this case, the illumination controller 300 can not accumulate and count the number of the dimming signal Ssw. In order to avoid the foregoing problem, an energy storage element 365 can be added to the illumination driving system. The energy storage element 365 includes a resistor R, a Zener diode Z, an input capacitor Cin, and a diode D, so as to provide a driving voltage VDD to the illumination controller 300 for operation. When the DC input power source Vin starts, the current charges the input capacitor Cin through the resistor R until the voltage drop thereof approximates to the breakdown voltage of the Zener diode Z. When the users switch the switches of the illumination driving system and cause the DC input power source Vin to be cut off, such that the DC input power source Vin can not provide the electric power temporarily, the input capacitor Cin can continuously provide the enough driving voltage VDD in the predetermined time period by the stored electric power, such that the illumination controller 300 continuously operates to count the dimming information inputted by the users. In order to further extend the time length of which the input capacitor Cin maintains the illumination controller 300 to continuously operate, a mode switching circuit 315 may be added. The mode switching circuit 315 detects the driving voltage VDD and starts to operate when the driving voltage VDD is raised up above a first predetermined value. At this time, the illumination controller 300 operates in a first operating mode, i.e. a normal operation. When the driving voltage VDD falls down below a second predetermined value, the mode switching circuit 315 outputs a power-saving signal Re to turn off parts of circuits or all of the circuits in the duty cycle control circuit 320. At this time, the illumination controller 300 operates in a second operating mode, i.e. a power-saving mode. The power consumption of the illumination controller in the second operating mode is lower than that of the illumination controller in the first operating mode. Accordingly, when the users cut off the supply of the DC input power source Vin and causes the driving voltage VDD falls down, the illumination controller 300 lowers the power consumption of the operation to extend the time length of which the input capacitor Cin maintains the illumination controller 300 to continuously operate. Furthermore, the diode D of the energy storage element 365 can be coupled to the transformer T2 of the converting circuit 360. When the converting circuit 360 is in the normal operation, the electric power can be provided to the energy storage element 365 through the diode D.

FIG. 5 is a schematic circuit of an illumination driving system according to a third embodiment of the invention. Referring to FIG. 5, the illumination driving system includes an illumination controller 400 and a converting circuit 460. The converting circuit 460 receives a DC input power source Vin and converts the DC input power source Vin into an output voltage so as to drive a light source 470. In the present embodiment, the light source 470 is a light emitting diode (LED) module and the converting circuit 460 is a DC/DC boost converter. The converting circuit 460 mainly includes an inductor L, a rectifying diode D, an output capacitor C and a switch SW. The illumination controller 400 generates a control signal CON to control the states of the switch SW, so as to control the value of the electric power provided to the light source 470 by the converting circuit 460. The illumination controller 400 includes a dimming unit 410 and a control unit, wherein the control unit includes a duty cycle control circuit 420 and a feedback unit 430.

In the present embodiment, the DC input power source Vin is generated from an AC voltage VAC by a bridge rectifier 480 through a switch SW1 in a switch module 490, and a dimming converting circuit 450 is coupled to a voltage source VCC. Users can transmit the required dimming ratio to the illumination controller 400 in a manner corresponding to the voltage change of dimming signal Ssw by switching a switch SW2 in the switch module 490. Herein, the switch SW1 in the switch module 490 is coupled to the DC input power source Vin and may be an illumination switch assembled on the wall, and the switch SW2 in the switch module 490 servers as a dimming switch. The dimming converting circuit 450 is formed by two resistors and a capacitor. When the switch SW2 is switched by users and a dimming signal Ssw is generated by the dimming converting circuit 450. The capacitor can avoid erroneous determination due to noise interference, and the two resistors serve as a voltage divider which can convert the voltage of the voltage source VCC into a voltage with a lower and suitable level.

The dimming unit 410 receives a dimming signal Ssw and correspondingly generates a dimming control signal DIM according to the number of the dimming signal Ssw. The feedback unit 430 receives a feedback detecting signal FB representing the state of the light source 470 and accordingly generates a feedback signal Comp. The feedback detecting signal FB may represent a voltage applied to the light source 470 or a current flowing through the light source 470. The duty cycle control circuit 420 is coupled to the dimming unit 410 and the feedback unit 430 to receive the dimming control signal DIM and the feedback signal Comp. Accordingly duty the cycle control circuit 420 generates a control signal CON to switch the switch M1 of the converting circuit 460. When the switch M1 is turned on, the electric power from the DC input power source Vin is stored in the inductor L and an electric power stored in the output capacitor C is provided to drive the light source 470. When the switch M1 is turned off, the electric power from the DC input power source Vin is stopped and the stored electric power in the inductor L is released to be stored in the output capacitor C and drive the light source 470. Accordingly, the output voltage Vout of the converting circuit 460 is stabilized, and the illumination controller 400 controls the electric power provided to the light source 470 through the converting circuit 460.

As the above description, the invention completely complies with the patentability requirements: novelty, non-obviousness, and utility. It will be apparent to those skilled in the art that various modifications and variations can be made to the structure of the invention without departing from the scope or spirit of the invention. In view of the foregoing descriptions, it is intended that the invention covers modifications and variations of this invention if they fall within the scope of the following claims and their equivalents.

What is claimed is:

1. An illumination controller, adapted to control a converting circuit to convert an electric power of a DC input power source to drive a light source, the illumination controller comprising:
a dimming unit receiving a dimming signal and correspondingly generating a dimming control signal according to the number of level change of the dimming signal; and
a control unit controlling the electric power provided to the light source by the converting circuit according to the dimming control signal, so as to adjust a brightness of the light source.

2. The illumination controller as claimed in claim 1, wherein the illumination controller is coupled to the DC input power source to receive a driving voltage, and the driving voltage provides the electric power required by the illumination controller for operating.

3. The illumination controller as claimed in claim 1, wherein the control unit comprises a soft-start unit, and the soft-start unit provides a soft-start process when the control unit adjusts the brightness of the light source in burst dimming.

4. The illumination controller as claimed in claim 1, wherein the control unit comprises:
a feedback unit receiving a feedback detecting signal to generate a feedback signal, wherein the feedback detecting signal represents an electric characteristic of the light source; and
a duty cycle control circuit generating at least one control signal to adjust a value of the electric power provided to the light source by the converting circuit, wherein a duty cycle of the at least one control signal is determined according to the feedback signal.

5. The illumination controller as claimed in claim 4, wherein the control unit further comprises a soft-start unit, and the soft-start unit provides a soft-start process when the control unit adjusts the brightness of the light source in burst dimming.

6. The illumination controller as claimed in claim 4, wherein the illumination controller is coupled to the DC input power source to receive a driving voltage, and the driving voltage provides the electric power required by the illumination controller for operating.

7. The illumination controller as claimed in claim 6, wherein the illumination controller determines to operate in a first operating mode or a second operating mode according to the driving voltage, wherein a power consumption of the illumination controller in the first operating mode is greater than that of the illumination controller in the second operating mode.

8. The illumination controller as claimed in claim 7, wherein the control unit further comprises a soft-start unit, and the soft-start unit provides a soft-start process when the control unit adjusts the brightness of the light source in burst dimming.

9. The illumination controller as claimed in claim 4, wherein the control unit determines whether the light source stays in a first state or in a second state according to the feedback detecting signal, and the control unit controls the electric power provided to the light source by the converting circuit according to the dimming control signal when the light source stays in the second state.

10. The illumination controller as claimed in claim 9, wherein the dimming unit receives the dimming signal and correspondingly generates the dimming control signal according to the number of level change of the dimming signal when the light source stays in the second state.

11. The illumination controller as claimed in claim 9, wherein the control unit further comprises a soft-start unit, and the soft-start unit provides a soft-start process when the control unit adjusts the brightness of the light source in burst dimming.

12. An illumination driving system, adapted to drive a light source, the illumination driving system comprising:
a converting circuit coupled to a DC input power source and converting an electric power of the DC input power source to drive the light source to emit light; and
an illumination controller generating at least one control signal to control the converting circuit;
wherein the illumination controller detects a voltage level of a dimming signal to control the electric power of the converting circuit for driving the light source according to the number of voltage change of the a dimming signal, so as to adjust a brightness of the light source.

13. The illumination driving system as claimed in claim 12, further comprising a switch coupled to a voltage source, wherein the illumination controller detects a switching number of the switch and accordingly adjusts the brightness of the light source.

14. The illumination driving system as claimed in claim 12, further comprising a dimming converting circuit coupled to the DC input power source, wherein the dimming converting circuit converts the voltage change of the DC input power source into a dimming signal, and the illumination controller controls the electric power of the converting circuit for driving the light source according to the number of the dimming signals.

15. The illumination driving system as claimed in claim 14, further comprising a switch coupled to the DC input power source for users to couple or dis-couple the converting circuit to the DC input power source.

16. The illumination driving system as claimed in claim 14, further comprising a switch coupled to the DC input power source, wherein the illumination controller detects a switching number of the switch according to the voltage change of the DC input power source and accordingly adjusts the brightness of the light source.

17. The illumination driving system as claimed in claim 14, further comprising an energy storage element coupled to the DC input power source to store the energy power, wherein the energy storage element provides the stored energy power to maintain the illumination controller to continuously operate for longer than a predetermined time period when the DC input power source is cut off.

18. The illumination driving system as claimed in claim 17, further comprising an input capacitor coupled to the DC input power source to provide a driving voltage to the illumination controller, wherein the illumination controller determines to operate in a first operating mode or a second operating mode according to the driving voltage, wherein a power consumption of the illumination controller in the first operating mode is greater than that of the illumination controller in the second operating mode.

19. The illumination driving system as claimed in claim 14, wherein the light source is a light emitting diode (LED) module or a cold cathode fluorescent lamp (CCFL) module.

20. The illumination driving system as claimed in claim 19, further comprising a switch coupled to the DC input power source, for users to couple or dis-couple the converting circuit to the DC input power source.

21. The illumination driving system as claimed in claim 12, wherein the converting circuit comprises a first power storage unit, a second power storage unit and a switch unit, the first power storage unit stores the electric power from the DC input power source when the switch unit is under a first state and releases the stored electric power to the second power storage unit when the switch unit is under a second state, and the second power storage unit stores electric power from the first power storage unit when the switch unit is under the second state and releases the stored electric power to the light source when the switch unit is under the first state.

22. The illumination driving system as claimed in claim 21, further comprising a switch coupled to the DC input power source, wherein the illumination controller detects a switching number of the switch according to the voltage change of the DC input power source and accordingly adjusts the brightness of the light source.

23. The illumination driving system as claimed in claim 21, further comprising a dimming converting circuit coupled to the DC input power source, wherein the dimming converting circuit converts the voltage change of the DC input power source into a dimming signal, and the illumination controller controls the electric power of the converting circuit for driving the light source according to the number of the dimming signals.

24. The illumination driving system as claimed in claim 21, further comprising a switch coupled to the DC input power source for users to couple or dis-couple the converting circuit to the DC input power source.

25. The illumination driving system as claimed in claim 21, wherein the control unit adjusts the brightness of the light source in burst dimming.
